(19) United States
(12) Patent Application Publication
(10) Pub. No.: US 2007/0236358 A1
(43) Pub. Date: Oct. 11, 2007

(54) SMOKE DETECTOR SYSTEMS, SMOKE DETECTOR ALARM ACTIVATION SYSTEMS, AND METHODS

(76) Inventors: Thomas T. Street, Fairfax Station, VA (US); Frederick Williams, Accokeek, MD (US); John Farley, Burke, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/278,709

(22) Filed: Apr. 5, 2006

(51) Int. Cl. G08B 17/10

(52) U.S. Cl. 340/628; 200/61.03

(57) ABSTRACT

A smoke detector system includes a plurality of smoke alarm devices individually configured to detect smoke and output an acoustic signal of predetermined frequency. The plurality of smoke alarm devices are individually configured to communicate with each other via wireless acoustic communication.

### TECHNICAL FIELD

Aspects of the invention generally relate to smoke detector systems smoke detector alarm activity systems, and methods. Aspects of the invention also relate to methods for using smoke alarm horn as a method of wireless acoustic communication between smoke alarms.

### BACKGROUND OF THE INVENTION

Smoke detectors and alarms are important home safety devices. Ionization chamber and photoelectric smoke detectors are the two most common types available commercially.

The NFPA 1 00 Life Safety Code requires that all smoke alarms in new constructions be interconnected. The interconnected smoke alarms allow all the smoke alarms to sound if any individual smoke alarm detects smoke. This technique allows a decrease in egress times and provides life protection for occupants if a smoke alarm happens to sound in the farthest part of a home.

Residential smoke alarms used wired connections between smoke detectors to notify other smoke alarms, included in an alarm system or network, to an alarm condition and also to alarm all the smoke detectors. Wired connections between smoke detectors in the currently available smoke alarm system is cumbersome. Furthermore, currently available smoke detectors and alarms require transmitter circuitry and a receiver circuitry. These transmitter and receiver circuitry not only add hardware complexity to a smoke alarm but also increase the cost of manufacture.

Accordingly, there is a need to overcome the above identified problems.

### SUMMARY OF THE INVENTION

Individual smoke detectors include a 85-db alarm horn that is used to sound an alarm. If such alarm is used to transmit an acoustic signal to other smoke alarms, a transmitter can be eliminated from each independent smoke detector. The acoustic signal of an alarming smoke detector's 85-db alarm horn that is used as a wireless transmitter would eliminate at least half of the electronic circuitry that would be needed for a smoke detector. An alarming detector can transmit the alarm identifying a coded signal and modulating the alarm horn frequency, and transmitting the modulated alarm horn frequency to other smoke detectors of a smoke detector network.

The acoustic signal would then be received and detected in each independent smoke detector's receiver initiating an alarm condition in such smoke detector and sounding a horn of such smoke detector. This approach would enable a battery powered smoke alarms to be used to protect residential spaces in lieu of hardwired AC powered alarms, thereby cutting down on installation costs and protecting hard-to-cover spaces without hardwiring power and interconnected control circuits. Moreover, in the event of power outage, the wireless alarm system as described in various aspects of the invention would function.

In one aspect, a mass spectrometer includes a plurality of smoke alarm devices individually configured to detect smoke and output an acoustic signal of predetermined frequency, the plurality of smoke alarm devices being individually configured to communicate with each other via wireless acoustic communication.

In another aspect a smoke detector system includes a plurality of smoke alarm devices individually configured to detect smoke and output an acoustic signal of a predetermined frequency, the plurality of smoke alarm devices being individually configured to communicate with each other via wireless acoustic communication, wherein each of the smoke alarm devices are preset to an identical code corresponding to a specific frequency: and further wherein the acoustic signal received by one of the smoke alarm devices is compared with a predetermined code established in the another of the smoke alarm devices, and if there is a match, the another of the smoke alarms enters into an alarm state and outputs an acoustic signal.

In an additional aspect, a communication method between a plurality of smoke alarm devices of a smoke detector system includes activating an alarm device of the plurality of smoke alarm devices upon detecting at least one of a smoke or fire: modulating the alarm using a predetermined digital code to produce a modulated signal: transmitting the alarm via wireless acoustic signals, the acoustic signals including a string of modulated digital values; receiving the string of digital values by another of the smoke alarm device; comparing the string of digital values with data stored in the another of the smoke alarm device; and generating an alarm by another of the smoke alarm device if a match is detected between the string of digital values and the data stored.

### BRIEF DESCRIPTION OF THE DRAWINGS

Preferred embodiments of the invention are described below with reference to the following accompanying drawings.

FIG. 1 is a high-level schematic of a smoke detector system.

FIG. 2 is a schematic of a smoke detector as shown in FIG. 1.

FIG. 3A is a methodology illustrating exemplary steps involved in generating an acoustic signal by a smoke detector as shown in FIG. 1.

FIG. 3B is a methodology illustrating exemplary steps involved in receiving the acoustic signal that is generated by a smoke detector as shown in FIG. 1.

### DETAILED DESCRIPTION OF THE PREFERRED EMBODIMENTS

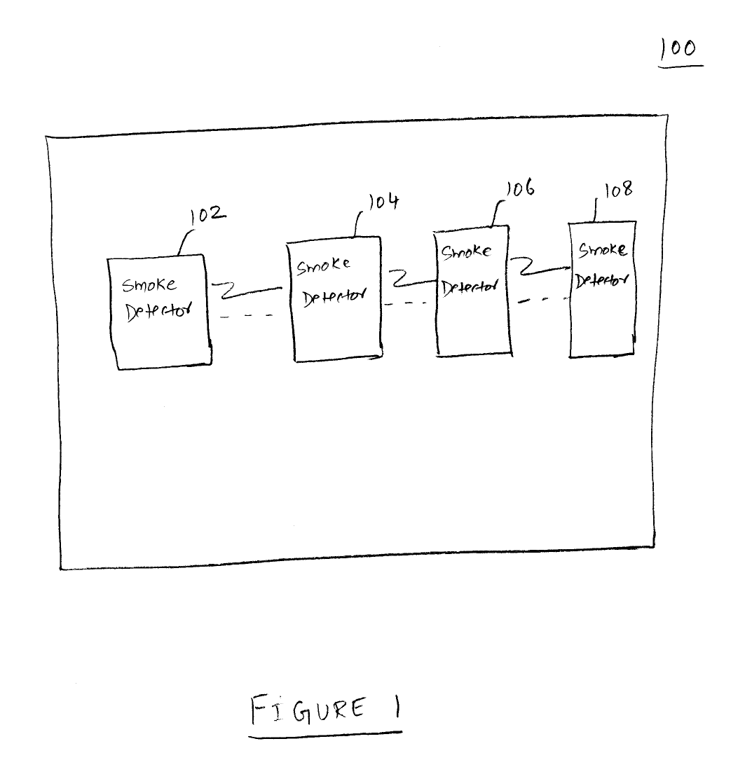

FIG. 1 is a high level schematic of a smoke detector system 100 having a plurality of individual smoke detectors 102, 104, 106, 108. Each of the individual smoke detectors 102-108 are configured to wirelessly (e.g. acoustic) communicate with other smoke detectors of the system 100. Further, each of the individual smoke detectors 102-108 may be identical in design. The smoke detectors are also referred to as smoke alarm devices. Each of the smoke detectors 102-108 is configured to detect smoke, and to transmit and receive acoustic signals. Acoustic signals are also referred to herein as acoustic alarms. For ease of illustration only a few individual smoke detectors are illustrated in FIG. 1. A larger or smaller number of smoke detectors in a smoke detector system is possible.

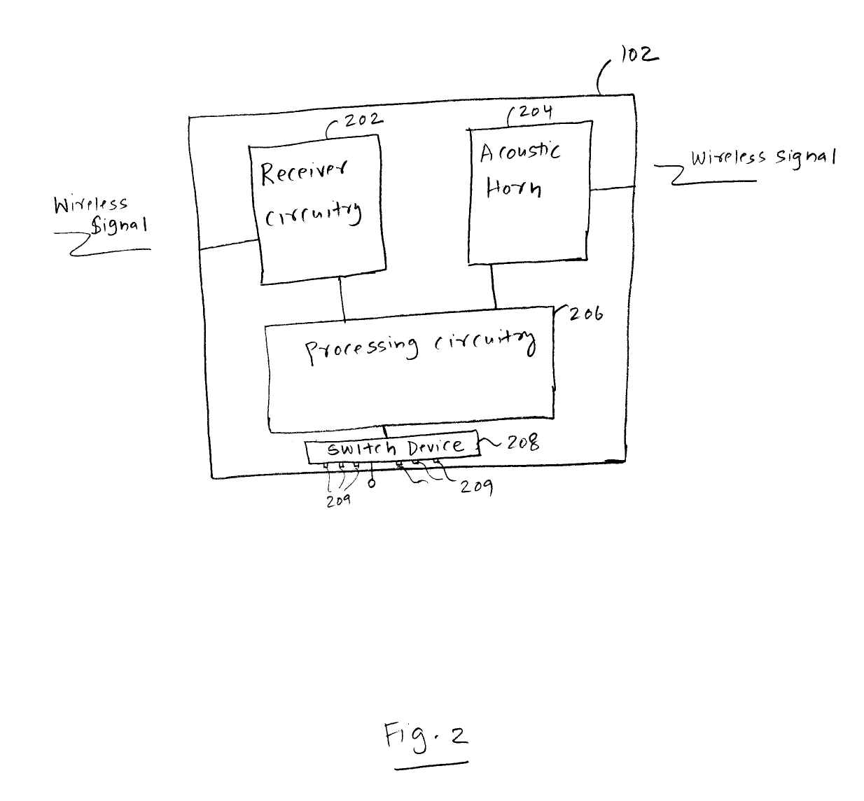

FIG. 2 shows a block diagram schematic of a smoke detector 102 shown in FIG. 1. The smoke detector 102 includes receiver circuitry 202, an acoustic horn (e.g., speaker) 204, processing circuitry 206, and a switch device 208.

The receiver circuitry 202 is a configured to wirelessly receive an acoustic signal from a smoke detector, such as smoke detector 104, of the smoke detector system 100. The received acoustic signal is provided to the processing circuitry 206 for further processing, which can include for example, demodulation.

The acoustic horn 204 is configured to generate an acoustic alarm. An alarm in the 85 decibel range can be used. Alarms of the acoustic frequencies can be generated as desired. The acoustic horn 204 is controller by the processing circuitry 206.

The processing circuitry 206 is configured to control the operation of the smoke detector 102. The processing circuitry 206 is also configured to detect smoke and generate and detect acoustic signals. In one embodiment, acoustic signals generated by the acoustic horn 204 are modulated using a digital code by turning the acoustic signal “on” and “off”. In another embodiment, the frequency of the acoustic signal can be shifted (e.g., frequency shift keying (FSK)) for a specific period of time in order to modulate the digital code.

In the embodiment where the acoustic signals are turned “on” and off”, a “1” is represented by the acoustic horn 204 being “on” and a “0” is represented by the acoustic horn 204 being “off”. In the embodiment of the FSK a “1” is represented by the acoustic horn 204 operating at one frequency for a fixed period of time and a “0” is represented by the acoustic horn operating at another frequency for a fixed period of time. The digital code, for example, can be made up of a factory set preamble digital code of a predetermined length “X”, or a user-selectable system digital code of length “Y” Followed by a factory set end of transmission code having a predetermined length “Z”.

The digital code can be set by a user by using a switch device 208 having a plurality of switches 209 (e.g. minidip switches) that can be set to be either turned “on” or “off”. The number of switches 209 shown in FIG. 2 is merely for purposes of illustration. In one embodiment, the number of switches 209 can be proportional to the number of digits comprised in the digital code. For example, a switch setting of “on” selects a “1” which turns the acoustic horn 204 “on” for a fixed period of time or shifts the frequency of the acoustic signal, and a switch setting of “of” selects “0” which turns the acoustic horn 204 “off” for a fixed period of time or shifts the frequency of the acoustic signal. The digital code is represented by a plurality of switches 209 that are turned “on” or “off” with each of the switches 209 representing a digit in the digital code string. The digital code string follows a prefixed preamble code such as, for example, 011011 of 1010101 or any other code of specific length which is factory set.

The factory set prefixed digital code is used to alert the smoke detector 102 to an incoming digital code string. Each of the smoke detectors 102, 104, 106 and 108 comprised in the smoke detector system 100 is set to the same selectable digital code “Y”. Such selection enables the smoke detectors 102-108 to not interfere with the functioning of smoke detectors that are not comprised in the smoke detector system 100 but otherwise located in close proximity to the smoke detector system 100.

When the smoke detector 102 senses products of combustion (e.g., smoke) or reaches the smoke detector's present threshold of smoke, it activates the acoustic horn (e.g., alarm). As mentioned above, the processing circuitry 206 comprises electronic circuitry to sense smoke. The processing circuitry 206 also includes a storage device configured to store preset data with which measured data is compared. If a value of the measured data exceeds a value (i.e., threshold) of the present data, then the processing circuitry 206 activates the acoustic horn 204 and an alarm is generated. The processing circuitry 206 causes modulation of the alarm generated by the acoustic horn 204. The alarm is modulated in accordance with the digital code set by the plurality of switches 209. The modulated alarm is transmitted via wireless acoustic communication to be received by another smoke detector comprised in the smoke detector system 100 (FIG. 1)

Each of the smoke detectors 102-108 are configured to receive the acoustic signals generated by the acoustic horns and to compare the selectable code string “Y” to determine if the code matches the selectable code to which the smoke detector is set. For example, if the smoke detector 104 receives the acoustic signal generated by the acoustic horn 204 of the smoke detector 102, the selectable code string “Y” is compared with the selectable code string that is preset in the smoke detector 104. If a code match is detected, then the smoke detector receiving the code string is forced into the alarm mode and its acoustic horn transmits the digital code to any other smoke detectors that are set to the same detectable digital code string.

The smoke detectors, which are in the alarm mode, remain in such mode until the products of combustion or smoke clears. The receiving circuitry 202 of the smoke detectors in the smoke detector system 100 periodically check for the reception of the selectable code, and if received continues in the alarm mode. If the selectable code is not received by the receiving circuitry 202, the processing circuitry of the respective smoke detectors resets the smoke detectors to a no alarm state if the respective smoke detectors additionally stop detecting the smoke. For example, if the smoke detector 102 detects smoke, it sounds the alarm and thereby sets off alarms of other smoke detectors (e.g. 104. 106. 108) of the smoke detector system 100. Tile smoke detector 102 can be reset if it no longer detects the smoke, while the smoke detectors 104. 106, and 108 can be reset only when the smoke detector 102 is reset (or in the case when one of the smoke detectors 104, 106, and 108 also detect smoke, when that particular detector additionally stops detecting the smoke).

Acoustic signals received by the receiver circuitry 202 are forwarded to the processing circuitry 206 for further processing which can include demodulation.

The smoke detector 102 is configured to wirelessly receive an acoustic signal by the receiver circuitry 202 and transmit an acoustic signal generated by the acoustic horn 204. The processing circuitry 206 is configured to modulate the acoustic signal generated by the acoustic horn 204 as well as demodulate the acoustic signal received by the receiver circuitry 202. It will be appreciated that the smoke detectors (e.g., detectors 102. 104, 106. 108) described above with respect to FIGS. 1-2 are merely exemplary. As such the inventive concept can be used with respect to any other types of detectors (e.g. heat, CO₂, motion, particulates. etc.) or a combination thereof.

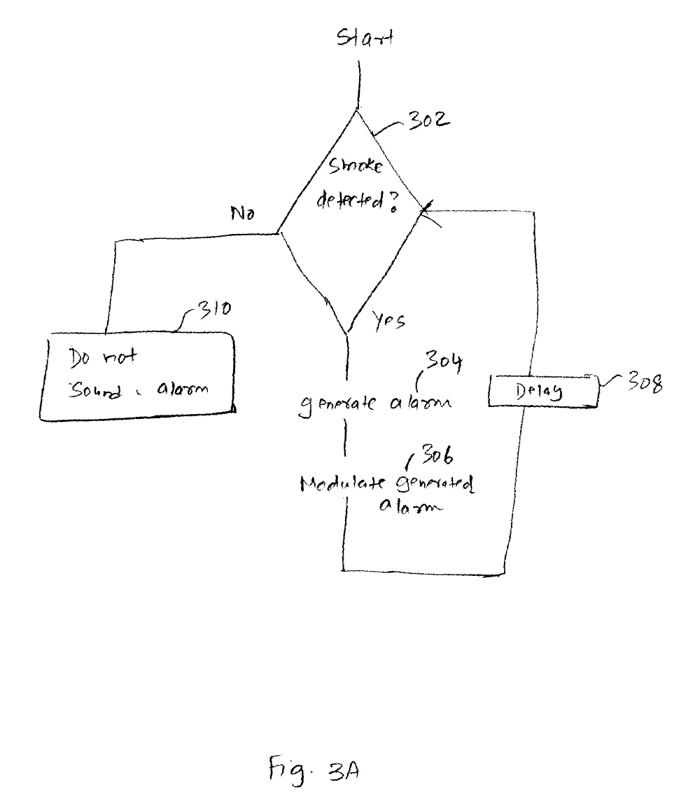

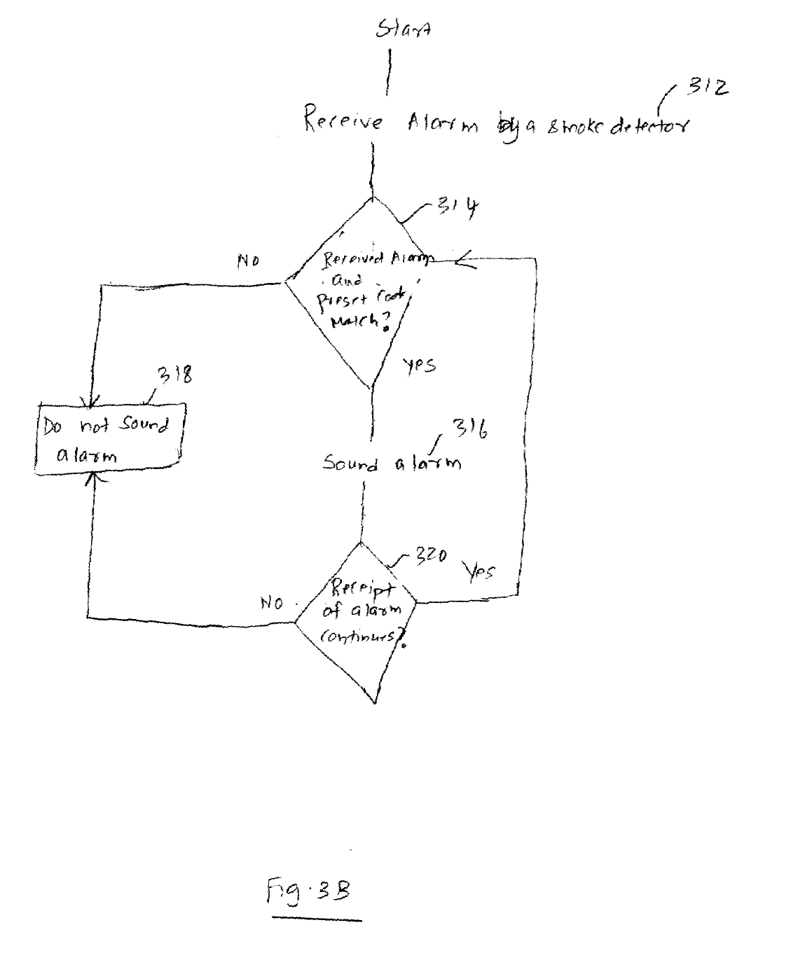

FIG. 3A is a methodology illustrating exemplary steps involved in generating an acoustic signal (e.g., alarm) by a smoke detector (e.g. smoke detector 102).

At a step 302, the presence or absence of smoke is determined. The method then moves to step 304 if smoke is detected. Otherwise, the method moves to step 310 and no alarm is generated.

At a step 304, an alarm is generated by the acoustic horn (e.g., acoustic horn 204). The method then moves to step 306.

At a step 306, the generated alarm is modulated using a digital code as described above with respect to FIG. 2. The modulated alarm is transmitted via wireless communication for receipt by other smoke detectors (e.g. smoke detectors 104, 106, 108) of the smoke detector system 100. After a predetermined delay as indicated at step 308, an inquiry is made to determine if the smoke still exists. If true, generation of the alarm is continued. Otherwise, generation of the alarm is stopped.

FIG. 3B is a methodology illustrating exemplary steps involved in receiving the acoustic signal (e.g., alarm) that is generated by the smoke detector 102 as described above with respect to FIG. 3A by a smoke detector (e.g., smoke detector 104).

At a step 312, the alarm transmitted from smoke detector 102 is received by the smoke detector 104. The method then moves to step 312.

At a step 314, an inquiry is made to determine if the digital code comprised in the received alarm matches the preset code of the smoke detector 104. If true, the method moves to step 316 and the smoke detector 104 sounds its alarm by activating its acoustic horn. Otherwise, the alarm is not activated by the smoke detector 104 as indicated at step 318.

At a step 320, an inquiry is made to determine if the smoke detector 104 continues to receive the alarm from the smoke detector 102. If the step is performed. Otherwise the method moves to step 318 and generation of the alarm is stopped.

A method and apparatus for wirelessly conveying alarm conditions between independent smoke detectors is needed that does not require substantial electronic circuitry and additional power to support such circuitry. In order to establish and maintain wireless communication between independent smoke detectors, each detector would typically need a transmitter and a receiver. By identifying a way to eliminate the need for the transmitter or the receiver in each smoke detector the circuitry needed for communication can be greatly reduced.

In compliance with the statute, the invention has been described in language more or less specific as to structural and methodical features. It is to be understood, however, that the invention is not limited to the specific features shown and described, since the means herein disclosed comprise preferred forms of putting the invention into effect.

What is claimed is:

1. A detector comprising:
a parameter detector portion operable to detect a parameter:
an acoustic signal detector portion operable to detect a first acoustic signal; and
an alarm portion operable to sound a second acoustic signal upon either one of detection of the parameter by said parameter detector portion and detection of the first acoustic signal by said acoustic signal detector portion.

2. The detector of claim 1, wherein said alarm portion is operable to sound the second acoustic signal with a frequency that is the same frequency as the first acoustic signal.

3. The detector of claim 1, wherein said parameter detector portion is operable to detect the parameter as one of the group consisting of smoke, heat, CO₂, motion, particulates and combinations thereof.

4. The detector of claim 1, further comprising a resetting portion operable to terminate sounding of the second acoustic signal by said alarm portion.

5. The detector of claim 4, wherein said resetting portion is operable to terminate sounding of the second acoustic signal by said alarm portion when said parameter detector portion does not detect the parameter.

6. A system comprising:
a first detector having a first parameter detector portion operable to detect a parameter, a first signal detector portion operable to detect a first acoustic signal and a first alarm portion; and
a second detector having a second parameter detector portion operable to detect the parameter, a second signal detector portion operable to detect a second acoustic signal and a second alarm portion,
wherein said first alarm portion is operable to sound the second acoustic signal upon either one of detection of the parameter by said first parameter detector portion and detection of the first acoustic signal by said first signal detector portion, and
wherein said second alarm portion is operable to sound the first acoustic signal upon either one of detection of the parameter by said second parameter detector portion and detection of the second acoustic signal by said second signal detector portion.

7. The system of claim 6, wherein said first alarm portion is operable to sound the second acoustic signal with a frequency that is the same frequency as the first acoustic signal.

8. The system of claim 6, wherein said first parameter detector portion is operable to detect the parameter as one of the group consisting of smoke, heat, CO₂, motion particulates and combinations thereof.

9. The system of claim 6, wherein said first detector further comprises a resetting portion operable to terminate sounding of the second acoustic signal by said first alarm portion.

10. The system of claim 9, wherein said resetting portion is operable to terminate sounding of the second acoustic signal by said first alarm portion only when said first parameter detector portion does not detect the parameter.

11. A method of providing a warning of a parameter using a system comprising a first detector and a second detector said method comprising:
detecting the parameter via the first detector;
emitting a first acoustic signal from the first detector;
detecting the emitted first acoustic signal via the second detector; and
emitting a second acoustic signal from the second detector.

12. The method of claim 11, wherein said detecting the parameter comprises detecting one of the group consisting of smoke, heat, CO₂, motion, particulates and combinations thereof.

13. The method of claim 11, wherein said emitting a second acoustic signal comprises emitting a second acoustic signal that has the same frequency as the first acoustic signal.
